(19) United States
(12) Patent Application Publication
(10) Pub. No.: US 2015/0096773 A1
(43) Pub. Date: Apr. 9, 2015

(54) STALK STOMPER

(71) Applicants: RICKY ALAN MILLER, New Holland, OH (US); Hoath Frost Johnson, Bloomingburg, OH (US)

(72) Inventors: RICKY ALAN MILLER, New Holland, OH (US); Hoath Frost Johnson, Bloomingburg, OH (US)

(21) Appl. No.: 14/045,725

(22) Filed: Oct. 3, 2013

(51) Int. Cl. A01D 63/02; A01D 45/02

(52) U.S. Cl. CPC A01D 63/02; A01D 45/028
USPC 172/540

(57) ABSTRACT

Disclosed is an apparatus that attaches to a harvester or other farm implements, and when pulled across a harvested field, such as a corn field, the apparatus crushes the stalks left after harvesting. The apparatus has attachment elements, upper and lower, with a spring tensioning therebetween, drag arms within which is a rotatable drum with stalk crushing elements.

PRIORITY TO PROVISIONAL

This application claims the benefit of a U.S. Provisional Application filed 3 Oct. 2012.

Field of endeavor to which the invention pertains.

Modern farming emphasizes low tillage of fields, natural decomposition of post-harvest plant matter, and reduced use of powered equipment. These points of emphasis are served with an improved design of stalk crusher preferably attached to a trailing part of a conventional corn harvester. The stalk crusher allows the previous growing-season's corn stalks and roots to decompose in situ, which preserves soil quality and prevents soil erosion.

The claimed invention in summarized form.

The stalk crusher is comprised of an upper, adjustable arm joined to an attachment assembly, and a lower double. strut arm that holds a stalk crushing drum, with the movable lower apparatus spring tensioned against the fixed upper arm. The apparatus attaches below a harvester implement or similar unit suited to being drawn through rows of corn.

### DESCRIPTION OF THE DRAWINGS

FIG. 1 and FIG. 2 depict components of one embodiment of the upper attachment assembly.

FIG. 3 depicts an embodiment of the cylinder with crushing elements.

FIG. 4 depicts the lower spring mount and H-bar that joins to the lower strut arms.

FIG. 5 depicts the upper and lower apparatus, with the rotatable cylinder, but without the spring.

FIG. 6 shows an alternative embodiment of a connector plate.

FIG. 7 depicts one embodiment of the invention attached to a harvester.

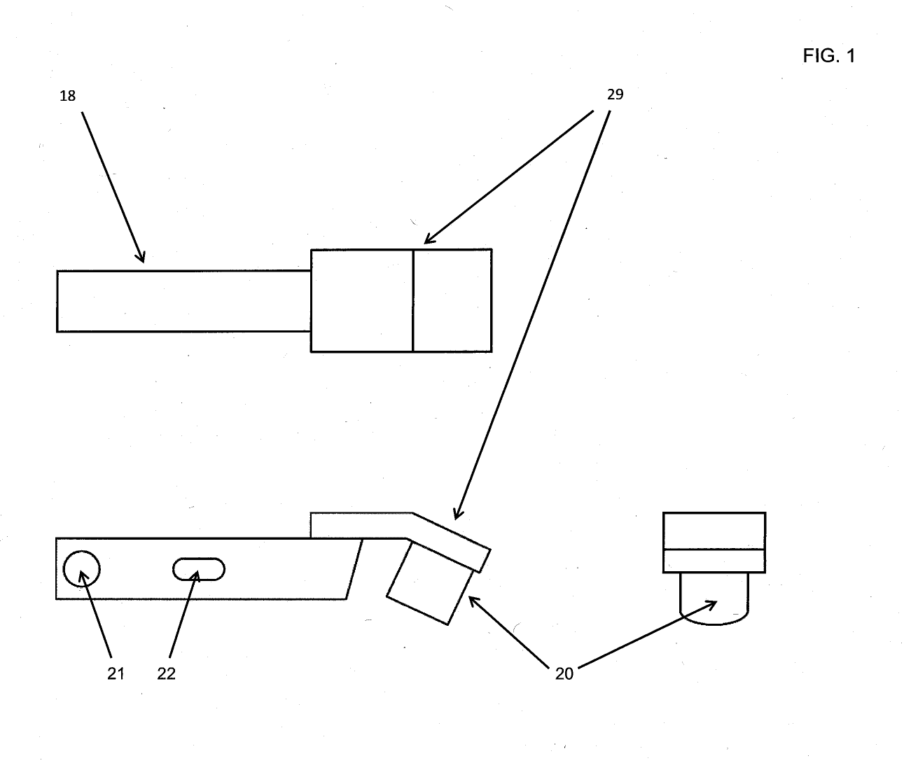

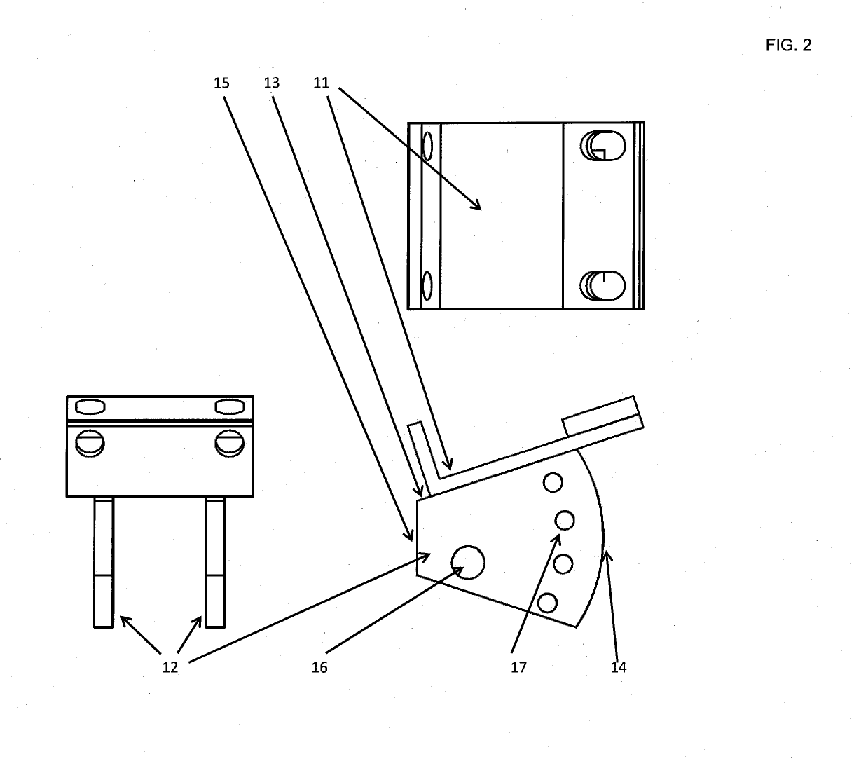

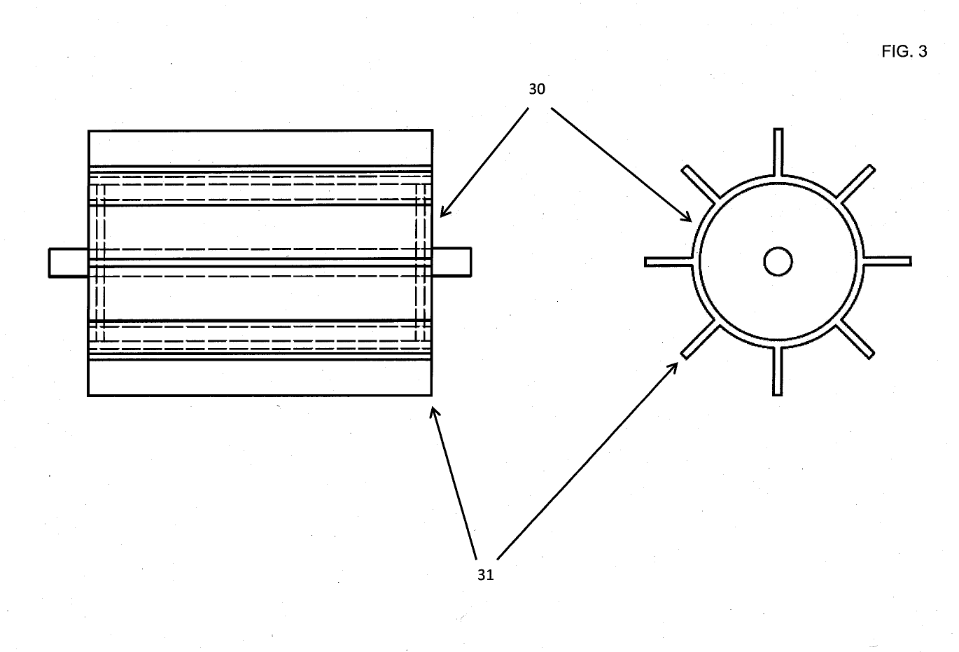

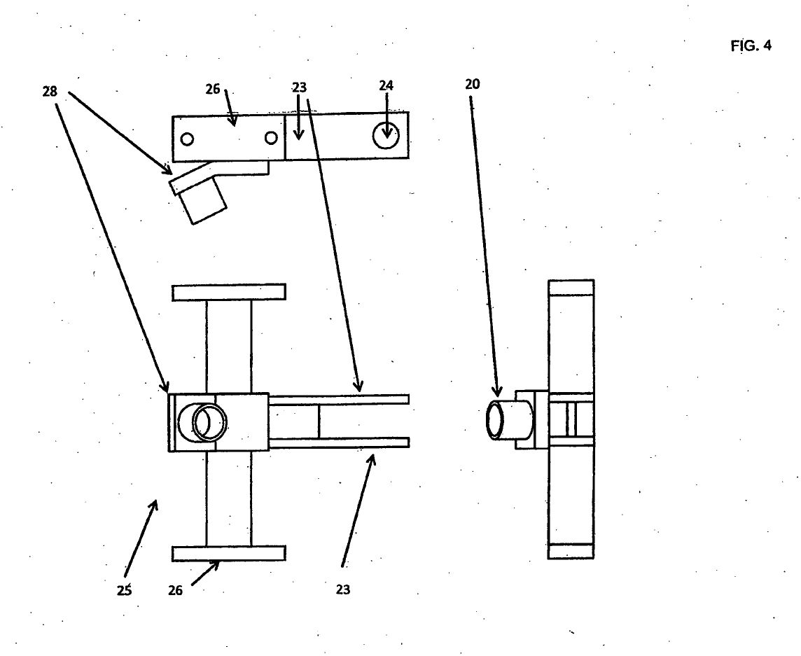

### DETAILED DESCRIPTION

Underneath the trailing end of conventional corn harvesting machinery 10 is some form of cross-bar or support bar. The design of stalk crusher, disclosed here, includes an attachment mount plate and assembly to removably attach the unit to that bar on a harvester. The attachments means will enable it to be clamped onto lower parts of other farm equipment, but it preferably is unlike the means used to attach the sort of implements drawn behind a tractor.

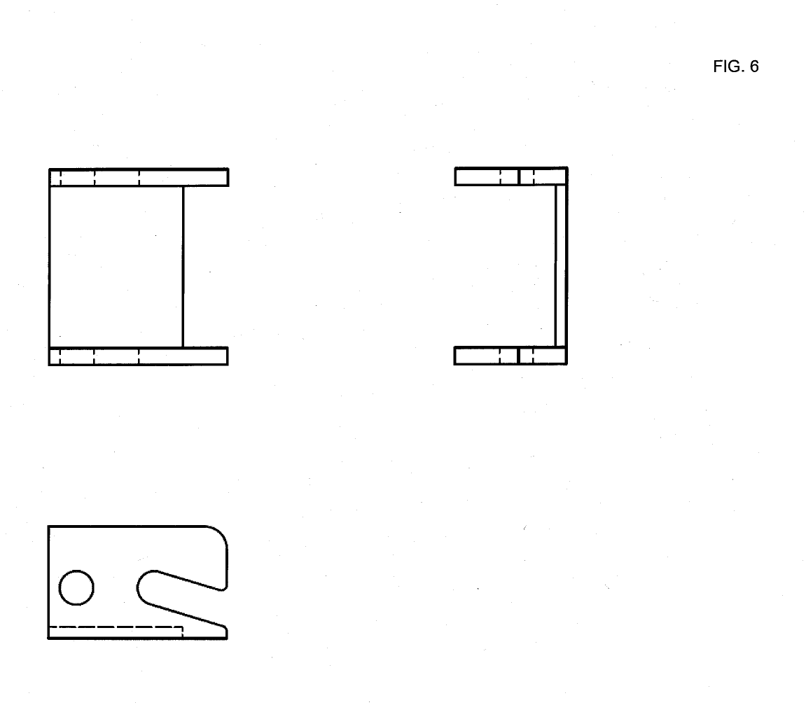

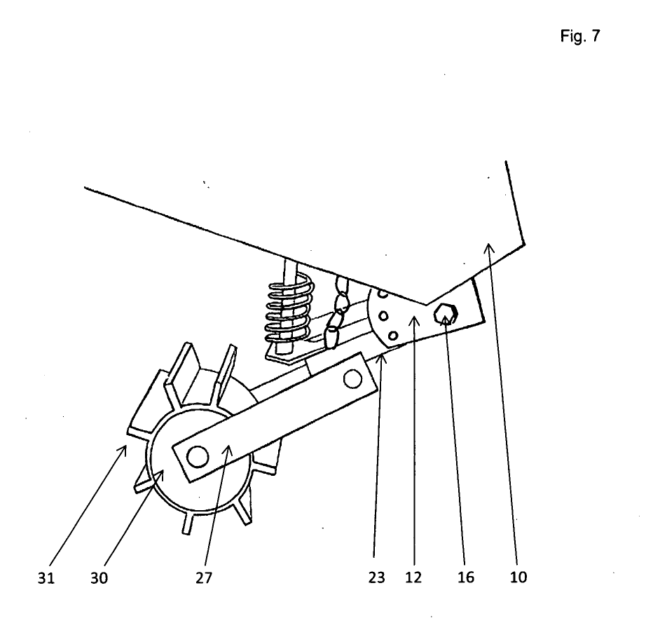

In one preferred embodiment, the attachment assembly is a plate and U-bolts, with the plate pressed against the cross-bar, and the U-bolts going around the bar then passing through the plate where the threaded ends are secured with nuts. An alternative embodiment has two or three plates that press against two or three sides of the bar on the harvester, and on the fourth side one or more bolts extend between plates on opposing sides of the bar and those bolts are secured with nuts. An alternative embodiment of a connector plate is shown in FIG. 6.

The other structural aspect of the attachment mount assembly, which is joined to the attachment mount plate pressed against the lower (ground facing) side of the cross-bar, are the stalk crusher attachment plates 12 with a pivot point 16.

In profile view, the cross-bar underneath the harvester runs horizontally, that is, parallel with the ground, and understandably, the attachment mount plate 11 is generally horizontal to be joined by mechanical pressure against the cross-bar on the underside of the harvester or implement. In relation to the horizontal line of the cross-bar, the stalk crusher attachment plates 12 are a pair of vertical elements extending from the attachment mount plate, downward toward the ground below the harvester. This pair of plates is fixed in parallel relation, with each plate having its upper edge 13 preferably welded to the attachment mount plate.

The stalk crusher attachment plates 12 are generally shaped like an equilateral triangle, although the preferable shape has the peak of the triangle cut off, and another part cut curvilinear 14 rather than straight across. One straight side of the triangle is the edge 13 welded preferably to the attachment mount plate 11. The straight edge cut-off part 15 of the triangle points forward of the harvester, and the curvilinear part 14 points rearward of the harvester when the apparatus is attached beneath the harvester. Each stalk crusher attachment plate 12 has a pivot point 16 along the centerline of the triangle shaped plate, adjacent to the cut off straight edge 5, and has a plurality of attachments points 17 adjacent to the curvilinear edge 14. In one preferred embodiment, the pivot point and the attachment points on the stalk crusher attachment plates, are holes drilled to a dimension suited for receiving joining hardware, preferably bolts or locking pins.

Joined to the attachment assembly, preferably being bolted to the stalk crusher attachment plates 12, is an upper bar 18 with a spring mount 19. Aligned with the spring mount 19, on a lower double strut arm is a lower spring mount. A coil spring (not shown) of appropriate, predetermined spring force, is held between the mounting elements on this upper bar 18 and lower arm, that is, upper spring mount 19 and lower spring mount 20.

The upper bar 18 is preferably a straight bar, with a pivot mounting point 21 and an attachment mounting point 22. In one preferred embodiment, the pivot mounting point and the attachment mounting point on the upper bar are holes drilled to a dimension for receiving attachment hardware, preferably bolts or equivalents, which pass through each stalk crusher attachment plate 12 and secure the upper bar 18 between those plates. The upper bar 18 extends from the pivot point 16 and pivot mounting point 21 to the attachment points 17 and attachment mounting point 22 and to the upper spring mount 19. In the preferable installation, the mount for the spring is a tubular element extending downward from the upper bar, with the coil spring fitted over the tubular element.

The lower double strut arm 25 with a spring mount 20 is preferably a pair of straight elements 23, each with a pivot point mounting hole 24. Unlike the upper bar, which has two attachment points 21 and 22 and so attaches rigidly, the lower double strut arm has one attachment point 24 to be joined at the pivot point 16, which enables the lower arm 21 freedom to move up and down within the space between the stalk crusher attachment plates 12.

The lower double strut arm is a pair of straight elements 23 preferably to permit these to move without bumping into the upper bar 18. One preferred embodiment of the lower double strut arm is an H-shaped element, with the lower spring mount 20 at the center of the H-crossbar, and attachment plates 26 forming the upstanding lines of the H. To these attachment plates 26 would be bolted or joined the drag arms 27.

In a profile view of one preferred pivot point assembly, starting at one end there is a stalk crusher attachment plate, then one of the pair of lower strut arms, then the upper arm, then the second of the pair of lower strut arms, then the other stalk crusher attachment plate, with a bolt passing through each of these elements.

As described, one end of each lower double strut arm 23 is attached at the pivot point 16. The other end of the lower double strut arm is formed as, or is joined to, the lower spring mount 20. This lower mounting point is preferably a tubular element over which the coil spring (not shown) is fitted. The lower mount 28 joined to the lower double strut arm and upper mount 29 joined to the upper bar, in one preferred embodiment, are flanges that, when the assembly is installed, are positioned generally parallel with respect to the other, and the tubular elements are joined to the flanges, with the coil spring extending from the flange on the lower mount to the flange on the upper mount. Also in a preferred embodiment, as assembled, the coil spring is mounted with the upper mount rearward of the lower spring mount, viz., rearward in the direction that the implement is drawn. The vee angle between the fixed upper bar and the pivotable lower strut arm is dampened by the coil spring therebetween. The upper and lower elements, and the plurality of mounting points on the stalk crusher attachment plates, work to provide means for adjusting the level of the barrel 30 and crusher elements 31 in relation to ground level, and those elements in conjunction with the coil spring provide means for adjusting how much force is imposed by the device upon the stalks in the ground. An optional feature is a guard, such as a chain connected between the upper attachment assembly and the lower double strut arm.

The operative aspect of crushing the stalks is done by a drag arm assembly attached to the lower double strut arms. The assembly, in its most basic embodiment comprises, a pair of drag arms with and axle therebetween on which is mounted a rotatable cylinder 30 with crushing elements 31. As the assembly is pulled by the harvester 10, the cylinder rotates, and the crushing elements crush the stalks due the force imposed by the coil spring upon the drag arm assembly.

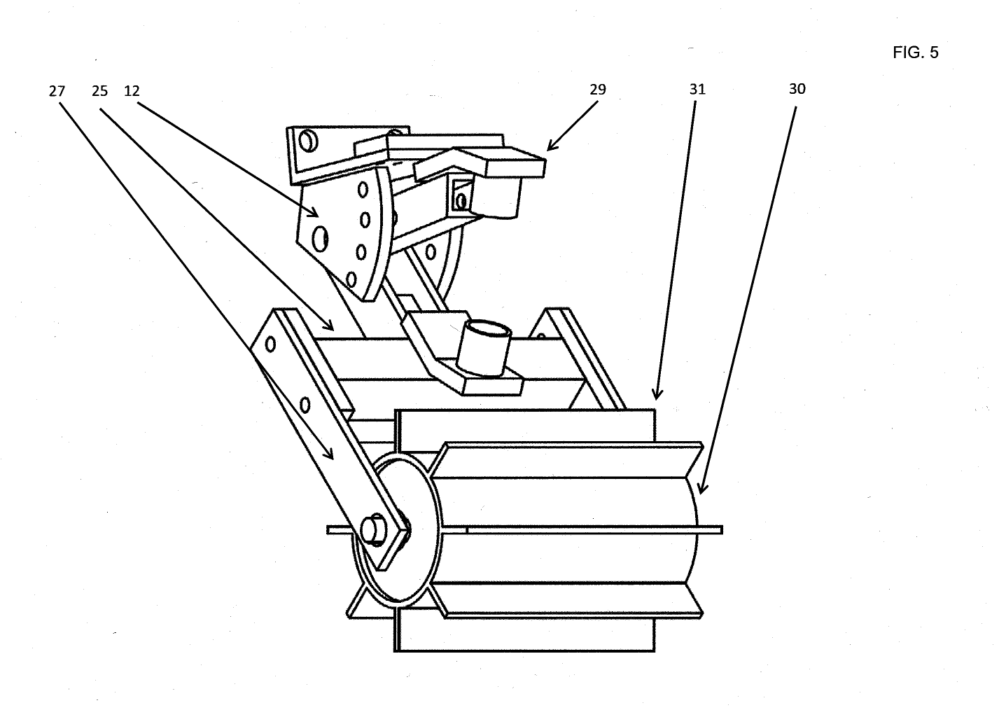

In one preferred embodiment, the lower double strut arms are joined to a cross bar positioned below the lower spring mount. This cross bar and the axle form opposite sides of a rectangular layout of the drag arm assembly, with the other two sides of the rectangle being the twin drag arms, as in FIG. 5. A version of that embodiment has these parts bolted together since equipment used for this purpose can become clogged with stalks, which creates a need to un-bolt the parts to clean the operative elements. The barrel or stalk crusher cylinder is shaped to rotate as it is pulled by the assembly attached to the harvester or drawn by other farm implement.

In one embodiment, the crusher elements 31 joined to the barrel are flat edge blades, spaced favorably to contact stalks planted a predetermined distance apart. These blades preferably have flat or blunt edges suited to crushing the stalks. From an end view of the barrel cylinder, the blades would be joined on lines that intersect the center of the cylinder and radiate outward to the flat edge.

Together, the assembly embodiment has the attachment means, the upper bar with spring mount, the stalk crusher attachment plates with a pivot point, the lower double strut arm with spring mount, and the twin drag arms with axle mounts for barrel with crusher elements. Photos of preferred embodiments are submitted herewith. Using the unit on a harvester, and having only one coil spring is preferred over units made for other implements or with multiple springs.

I claim:

1. Apparatus to be joined to and drawn along beneath a farm implement such as a corn harvester with an underside, horizontal cross-bar, said apparatus comprising
upper attachment means for attaching said apparatus, said upper attachment means comprised of an attachment mounting plate, at least one attachment plate with a pivot point and with at least one attachment point, and an upper bar with mounting means for a coil spring,
lower double strut arm means for pivotally connecting to said pivot point and connecting fixedly and adjustably to said at least one attachment point, a lower mount bar with mounting means for said coil spring, and with drag arms on opposite sides of said lower double strut arm means, and a barrel rotatably connected between said drag arms, said barrel having crushing means.

2. The apparatus of claim 1, further comprising a safety chain means connected to said upper bar and to said lower double strut arm means.

3. The apparatus of claim 1, wherein said lower double strut arm means are pivotally connected at a predetermined vee angle in relation to said upper bar.
